(19) United States
(12) Patent Application Publication
(10) Pub. No.: US 2015/0206076 A1
(43) Pub. Date: Jul. 23, 2015

(54) CLOUD BASED ENERGY PORTFOLIO BUILDER TO BUILD AND MANAGE ENERGY AND UTILITIES FOR GEOGRAPHICALLY DISTRIBUTED BUILDINGS

(71) Applicants: Sudhir K. Giroti, Wellesley, MA (US); Bhaskar Chandra Panigrahi, Southborough, MA (US)

(72) Inventors: Sudhir K. Giroti, Wellesley, MA (US); Bhaskar Chandra Panigrahi, Southborough, MA (US)

(73) Assignee: 1Efficiency, Inc., Framingham, MA (US)

(21) Appl. No.: 14/600,802

(22) Filed: Jan. 20, 2015

Related U.S. Application Data
(60) Provisional application No. 61/929,511, filed on Jan. 21, 2014.

(51) Int. Cl. G06Q 10/06; G06Q 50/16

(52) U.S. Cl. CPC G06Q 10/063; G06Q 50/16

(57) ABSTRACT

A system for data collection and aggregation may be used by property managers, property owners, and the like to maximize monetary savings as it relates to utility consumption. Generally, a software system and/or platform is provided which a user can employ to enter various parameters. The software can further be given permission to access user accounts connected to the utility service providers. Once a user portfolio has been established, the system automatically updates and analyzes the sourced data. The user can then manage their properties remotely and understand where and how monetary savings can be realized.

### CLAIM OF PRIORITY

This application claims priority to U.S. Application 61/929,511 filed on Jan. 21, 2014, the contents of which is herein fully incorporated by reference in its entirety.

### FIELD OF THE EMBODIMENTS

The field of the invention and its embodiments relate to a user friendly application and database which aggregates information relating to the efficiency and performance of properties. In particular, a system is employed that uses a user friendly graphical and forms-based interface to enable or provision one or more buildings and the monitoring of a property portfolio for the purpose of monitoring and analysis of energy expenditures and energy usage to help reduce overall cost, to improve energy efficiency, and to improve building performance.

### BACKGROUND OF THE EMBODIMENTS

Annually, billions of dollars are spent on energy expenditures, such as heating or cooling, for buildings and/or properties of which significant amount is wasted. For example, in the United States, approximately five million commercial and industrial buildings spend about $200 billion on energy expenditures, of which nearly 30% ($60 billion) can be saved through improved energy efficiency. However, much of these savings are untapped because many building owners, tenants, and investors do not properly appreciate the potential savings. According to United States Department of Energy, “information feedback can introduce savings of about 15% ($30 billion) or higher”—a significant business opportunity.

In addition, The International Energy Agency has stated that “customers respond to prices by switching suppliers and that shifting/reducing demand will help improve efficiency, flexibility, dynamism, and innovation throughout the electricity supply chain.” In turn, switching suppliers by consumers and property proprietors amounts to a $100 billion dollar market which has the potential to grow through customer education, system standardization, and easy user experience.

Nowadays, building owners get utility bills for electricity, water, gas, oil, sewer, and the like on a monthly or perhaps quarterly basis. These bills include usage & consumption information as well as monthly, quarterly, etc. cost information for every building. However, because multiple utility providers may serve electricity, water, gas, oil, etc. across multiple buildings, a property manager or property owner managing multiple buildings gets multiple bills from each separate utility. Each of these bills is not related to the other as utilities treat each building as a separate customer or separate account. This makes it difficult for recipients who have multiple buildings under management to understand the aggregated cost and consumption information across their portfolio of buildings.

Furthermore, it is also extremely difficult to compare buildings and analyze the cost and consumption across these buildings because each building is different, each is occupied for different uses, each building has different building characteristics, and each building may be located in different geographies. Aggregating data across a portfolio is very time consuming and even when aggregated, comparison may not be fair or equitable depending on the aforementioned and other not mentioned variables. Therefore, the capability to see a portfolio of buildings is paramount to manage energy across a diverse set of buildings located across different geographies with different characteristics in differing square footage. Further, building or compiling a portfolio of buildings will provide the capability to perform a fair comparison across the portfolio and also will provide the tools for a building owner, building manager, building operators, and/or tenants needed to improve energy and utility usage of their buildings and/or facilities performance.

Various devices are known in the art. However, their structure and means of operation are substantially different from the present disclosure. The other inventions fail to solve all the problems taught by the present disclosure. At least one embodiment of this invention is presented in the drawings below and will be described in more detail herein.

### SUMMARY OF THE EMBODIMENTS

The present invention and its embodiments generally describes and teaches a system that allows a building owner, manager, or the like to aggregate building utility consumption and expenditures in a way that allows the information to be managed and interpreted easily and efficiently. The system periodically updates, processes, and tracks the data as it comes into the system. An analysis can then occur which compares building within a portfolio in real time over various constraints applied to the analysis.

In one embodiment of the present invention there is a property management system having an audiovisual display for displaying and communicating desired content; a processor based computing device capable of being connected to a network; a computer readable storage medium storing one or more programs for execution by the processor based computing device, the one or more programs being capable of sourcing data from at least one utility provider associated with at least one property, wherein the sourced data is analyzed and compared to benchmark data, and wherein the sourced data is capable of being monitored in real time.

In another embodiment of the present invention there is a property management system having a processor based computing device capable of being connected to a network; a computer readable storage medium storing one or more programs for execution by the processor based computing device, the one or more programs being capable of sourcing data from more than one utility provider associated with more than one property, wherein the sourced data is used to create at least one property portfolio containing usage and expenditure data for the more than one utility provider for each of the more than one property.

In another aspect of the present invention there is a method of building a property management portfolio, the method having the steps of providing a computer readable storage medium storing one or more programs for execution by one or more processors; accessing the one or more programs via a processor based computing device capable of being connected to a network, wherein content access is determined by the user credentials supplied by a user; a user selecting a location of at least one property; the user selecting at least one utility associated with the at least one property; and the user selecting at least one utility service provider associated with the at least one utility. The method may further have the step of the one or more programs automatically sourcing data associated with each of the at least one property's utility service providers, and if it is the first time the system sources the data, then both current and historical data is sourced, and wherein if it is not the first time the system sources the data, then only the data modified since the last update is sourced.

In general, the present invention succeeds in conferring the following, and others not mentioned, benefits and objectives.

It is an object of the present invention to simplify the mechanism by which a portfolio of buildings/properties can be built.

It is an object of the present invention to provide a capability to build a portfolio of properties that includes old and new buildings, building of all types and sizes, buildings used for all purposes, buildings with old and new meters, devices and instruments.

It is an object of the present invention to simplify the means by which a portfolio of devices, building automation systems and other data can be aggregated into a portfolio.

It is an object of the present invention to provide a means by which a diverse set of buildings and devices located in different locations can be aggregated in an easy an affordable manner so that monitoring of these buildings, devices and systems can be streamlines, simplified and so that data can be viewed and managed easily, cost effectively and in real time or non-real time.

It is the object of the present invention to provide a capability to get data from other sources such as weather and other public data so that a building portfolio so built can be analyzed holistically based upon data that can influence its performance.

It is an object of the present invention to provide a system of property management that can be accessed by a user regardless of their location.

It is an object of the present invention to provide a system of property management that aggregates utility data into an easily digested format.

It is an object of the present invention to provide a system of property management that normalizes aggregated data to provide a mechanism of comparison.

It is an object of the present invention to provide a system of property management that reduces the number of bills received by a property manager, owner, or the like.

It is an object of the present invention to provide a system of property management that saves a user time and money.

It is an object of the present invention to provide a system of property management that enables effective management and monitoring of dissimilar properties.

It is an object of the present invention to provide a system of property management that provides utility consumption and expenditure data.

It is another object of the present invention to provide a system of property management that be used in conjunction with a variety of electronic devices.

It is another object of the present invention to provide a system of property management that enables one to manage and understand a property or groups of properties energy efficiency, maintenance requirements, costs per capita, and the like.

It is another object of the present invention to provide a system of property management that can be used by users of varying technical knowledge and experiences with electronic systems.

It is yet another object of the present invention to provide a system of property management that provides both current and historical data for a property or groups of properties.

### BRIEF DESCRIPTION OF THE DRAWINGS

FIG. 1 is a diagram illustrating a high level system overview of an embodiment of the present invention.

FIG. 2 is an example of a graphical user interface of an embodiment of the present invention.

FIG. 3 is a flowchart illustrating a method of building a property portfolio in accordance with the present invention FIG. 4 is a flowchart illustrating a process of provisioning data into the present invention.

FIG. 5 is a flowchart illustrating a process of monitoring a property portfolio in accordance with the present invention.

### DESCRIPTION OF THE PREFERRED EMBODIMENTS

The preferred embodiments of the present invention will now be described with reference to the drawings. Identical elements in the various figures are identified with the same reference numerals.

Reference will now be made in detail to each embodiment of the present invention. Such embodiments are provided by way of explanation of the present invention, which is not intended to be limited thereto. In fact, those of ordinary skill in the art may appreciate upon reading the present specification and viewing the present drawings that various modifications and variations can be made thereto.

The “building of the internet of things” or the concept that encompasses the highest, most generalized layer of intelligence and user interface that ties together connected devices and web services is an emerging race which this invention and its embodiments addresses. In order to create this “internet of things” (i.e. interconnected, data sharing devices) a building or interconnectivity must be achieved that allows all “internet of things” devices to share data and otherwise communicate across standard protocols. This invention and its embodiments focus strongly on this concept and bringing it to the masses in a formidable and precise package by creating a system that aggregates dissimilar data from a variety of sources and interprets it in a central location. The present invention and its embodiments provides for an interconnected “internet of things” system and methodology that provides color coding to real estate properties based on data sourced from and a variety of sources and compared mathematically against one another to signify performance and efficiency of dissimilar structures or properties.

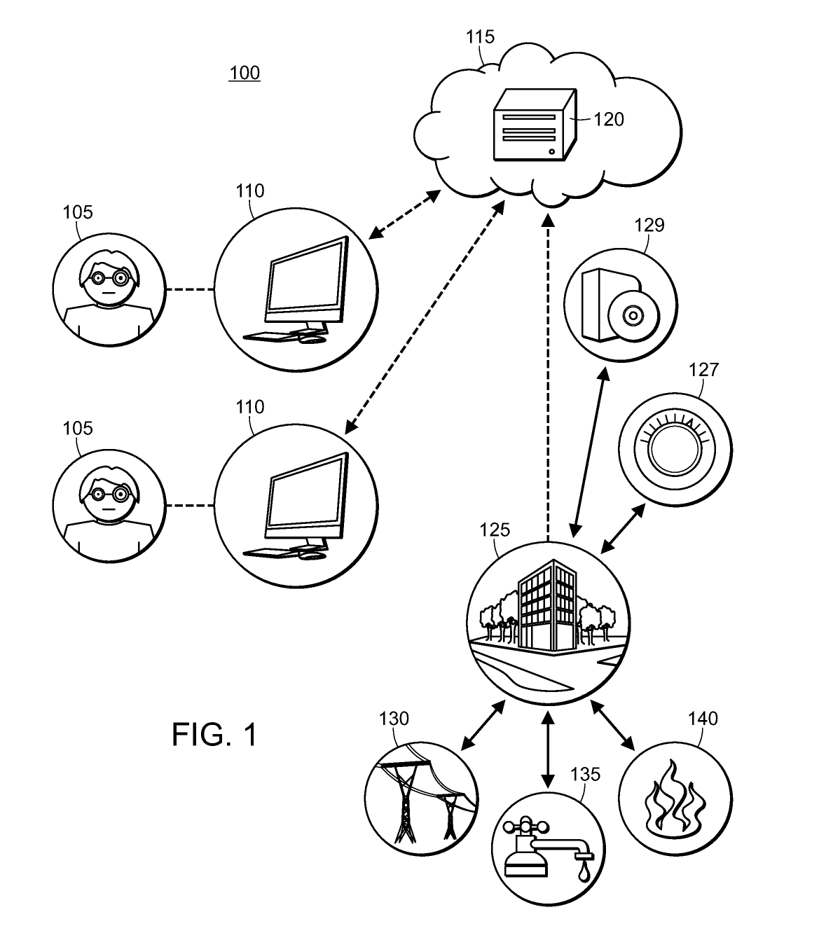

Referring now to FIG. 1, there is a high level system overview of an embodiment of the present invention. The system 100 generally includes an end user or users 105, a storage medium/software platform 120 which may exist in the cloud 115 and at least one (preferably multiple) properties 125.

Generally, the system 100 has a number of capabilities related to the building, provisioning, and managing of utility consumption and expenditures associated with various geographically related or unrelated properties. Thus, a user can create a custom property portfolio by aggregating the various properties' consumption and expenditure data in a way that enables the data to be managed easily and effectively. The software platform provides the building a portfolio of properties through a simplistic and non-technical “drag and drop” methodology combined with forms to take user input that facilitates the creation of a portfolio of properties. This portfolio or portfolios can then be managed and analyzed for numerous variables such as energy efficiency, property upgrade requirements, retrofitting the properties, etc.

After building one's portfolio, a user must “provision the data” in order to bring the usage and consumption data related to these buildings directly from the utilities that offer such services and other source such as internet enabled devices and third party systems in the cloud. The system 100 allows the data to periodically flow into the portfolio builder which processes and tracks the data. The system 100, as a whole, manages the data retrieved or sourced from multiple sources such as utilities and notes whether the data is dated or current and interprets it correctly.

Finally, the user can monitor their portfolio by analyzing the sourced data in the portfolio and comparing those values to other buildings within the portfolio. Such monitoring can be achieved in real time.

Thus, as described, there is a software program/storage medium 120 in the cloud 115. This enables the program to be accessed by a remote user anywhere in the world that access is permitted. A user 105 employs an electronic device 110 such as a laptop computer, desktop computer, PDA, tablet, cellular phone, multimedia players, gaming system, smart watch, and the like or any combination thereof. The above described general usage can then be performed with regard to one or many properties 125. The property 125 may be any residential, commercial, or industrial property, or various combinations of multiple types or single types of properties (i.e. multiple residential and commercial properties or multiple industrial properties).

Each property 125 typically will have a number of internet enables devices and appliances 127, software systems 129, and utilities such as electricity or electric 130, water 135, and gas/heating 140. There may be a number of other types of utilities and sub types under each category or classification of utilities. Each utility has certain consumptions attributed to each property 125 and expenditures to be shouldered by the property owner and eventually tenants relating thereto.

The internet enabled devices and appliances 127, such as a smart thermostat, and software systems 129 can comprise the larger “internet of things.” The idea behind the “internet of things” is that the interconnectivity of innumerable smart devices can enable monitoring and altering of systems which may or may not require human-human or human-computer direct interaction. Virtually any device or appliance is capable of being an “internet ready” device with the addition of a central processing unit, memory, and power sources or resources that enable it to provide information about itself or the environment in which it is contained. Thus, “internet of things” devices can be used to monitor and/or control mechanical and electrical (amongst others) systems in a property and systematically provide that information to another source. This information or data is aggregated by the system to enable efficient monitoring and comparison of benchmarks to facilitate an enhanced utility usage and building/property maintenance.

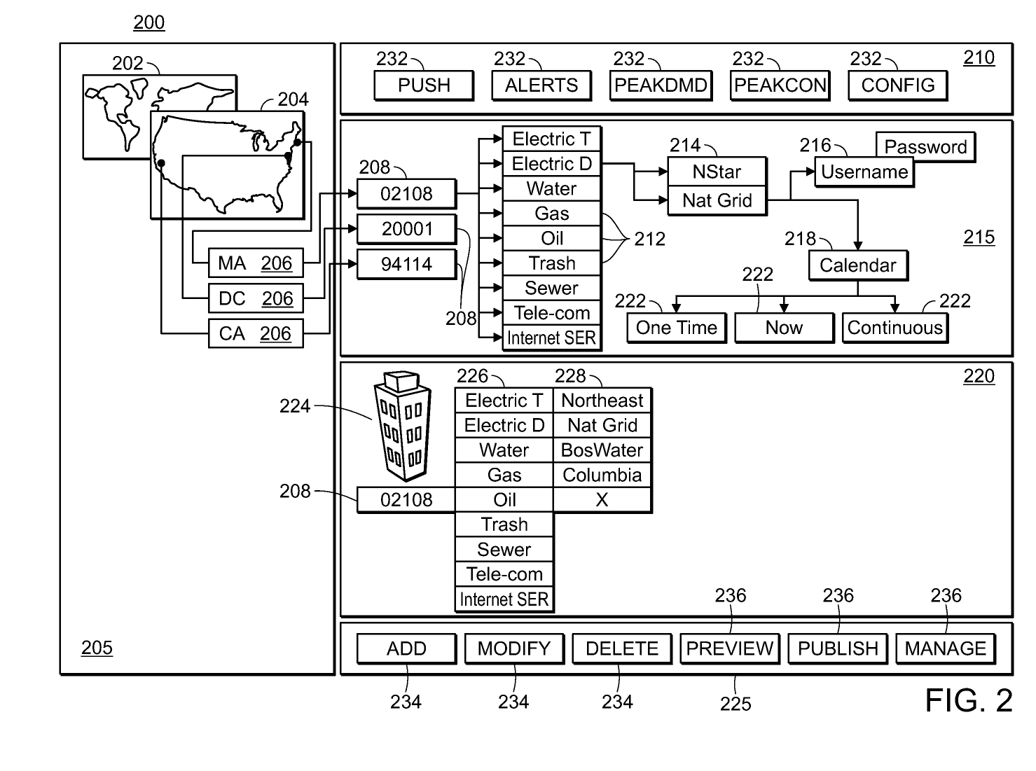

Referring now to FIG. 2, the system is generally a software platform that can be accessed by systems or users who have any traditional web browser (i.e. Internet Explorer, Chrome, Mozilla, etc.) commonly available on computers, laptops, tablets and/or mobile devices. Other users may be able to employ computing devices running various operating systems (i.e. Microsoft Windows, Linux, Apple iOS, etc.) that can be installed and used without a web browser to access the software. In addition, mobile device(s) such as tablets, cellular phones, smart watches, multimedia players, or gaming systems employing any one of a native mobile application, a hybrid mobile application, or a browser application.

The users interact with the system from a graphical user interface (dashboard) 200 with the capability to enter data from preset online forms. The system is preferably implemented using “responsive design capability” which means that this dashboard 200 adapts to the device it is running on. Thus, users who are using a computer or a larger tablet device will get a different user dashboard 200 in comparison to those using a smaller (screen) computing device such as a cellular phone.

As shown in FIG. 2, there is one example of a dashboard 200 consistent with an embodiment of the present invention. The dashboard 200 may be viewed as being broken up into a series of frames or sections. In the selection frame 205, there is a world map 202 for selection of the country where the particular property is located. Each country is selectable via a touch based or clickable selection. In some instances, one may wish to search by entering the specific name of a country.

Once a selection has been made, a country map 204 will enlarge so that specific states, regions, provinces, territories, and the like are made available for one to further select by the same or a different selection methodology. The state locators 206 identify any number of particular states, in this example, that are selected.

The builder frame 215 provides the tools and clickable buttons to build out one's portfolio. In this frame, the user may select from a series of zip codes 208 or location identifiers in order to specify a specific location for which the property is located.

This enables one to select a utility button 212 (electric, water, gas, trash, telecommunications, internet, etc.) upon which a utility provider 214 such as NStar, National Grid, AT&T, and other local and/or national service providers can then be selected. A user/account credential 216 such as a password may be required for configuring certain settings in the system and to properly correlate a particular utility account with a particular utility service provider. A calendar 218 feature will help users set up and configure the frequency with which the system will retrieve data from the utility service providers via the frequency selectors 222.

In the preview frame 220, the user can view and visualize the selections made in the selection frame 205 and the builder frame 215. Here, there is a representation identifying the property 224, zip code 208, utility type 226, and utility company 228. Edits can be made to a particular set up if there is incorrect or incomplete information contained within this frame.

The menu frame 225 contains clickable buttons coupled to directives for modifying the portfolio in some manner such as adding, deleting, or modifying existing material. Further, a user can use management buttons to preview, publish, and manage the portfolio.

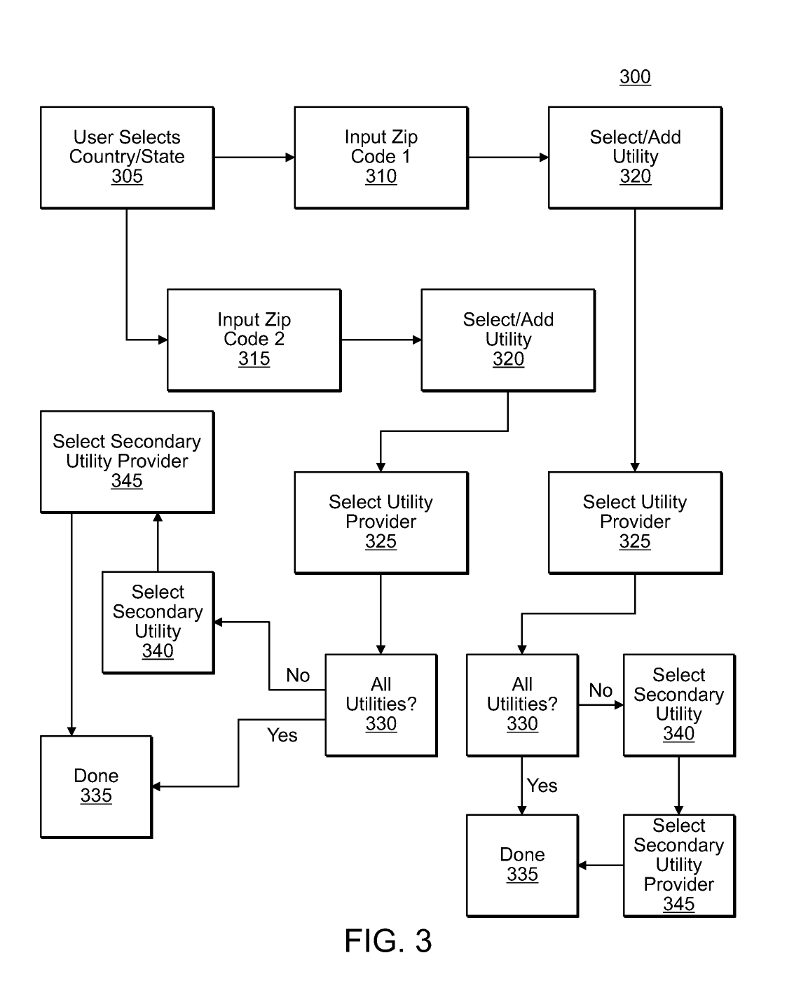

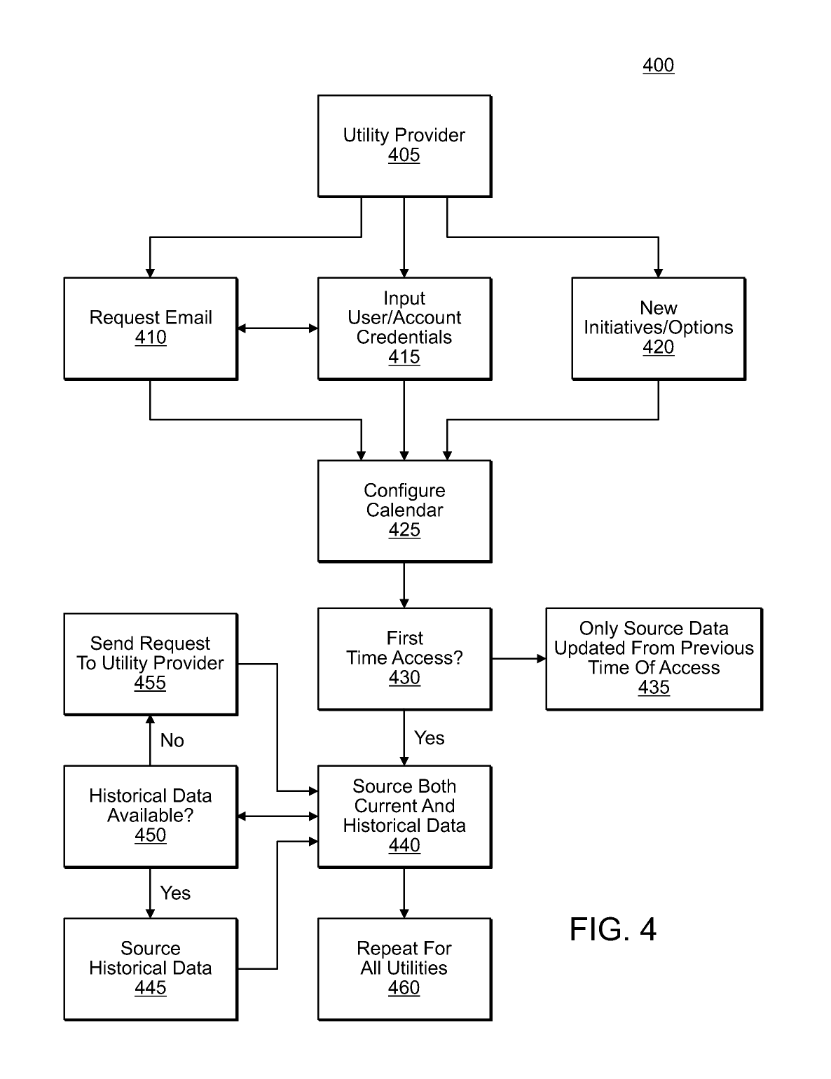

Referring to FIG. 3, there is a flowchart illustrating the process of building a portfolio of the present invention.

In step 305, a user selects a country and/or state, region, territory, province, and the like or any combination thereof to first identify the location of their property. Once the location has been sufficiently narrowed, adequate details about the surrounding area can be gathered.

In step 310, a user selects a particular location and further identifies that location using a zip code by inputting a first zip code. A user may also, as shown, select a second zip code in step 315. There is no limit on the number of zip codes or other similar identifying information to be used. This enables the building of wide ranging and encompassing property portfolios. Further, address information such as street location, physical address, building name, etc. may be required in order to adequately supply the correct information to the user.

In step 320, the selection of utilities can occur for each identified property. This is only limited by the types of utilities which are prescribed to a particular property. For example, one property may have water, electric, and gas whereas another may only use water, electric, and oil. By selecting each utility for each of the properties, a user can then select the particular utility provider.

In step 325, the particular utility provider is selected. The input of the zip code or other location identifier along with the utility type gives rise to a populated list of utility providers for that particular location. The user the selects each provider that services each of their respective properties.

In step 330, there is a check that the user has entered all the necessary utilities for each property. If all utilities have been entered, the process ends in step 335.

If all the utilities for a particular property have not been entered, then in step 345, the user can again select a utility provider or return to a previous screen to edit/modify their selections. In step 340, these utilities are then selected. Once all utilities have been added, the process end in step 335.

A user, in accordance with the above described “building” process, will have likely successfully built out their portfolio. In order to link their portfolio to the aforementioned utilities a user must provision the data into the built portfolio in the method 400 outlined in FIG. 4.

In step 405, there is a utility provider that has been identified by a user to supply a utility to a particular piece of property. In order to retrieve the property's specific usage, consumption, and other associated data username and/or password data is typically supplied by the user. However, as shown other implementations of data retrieval may be available.

In step 415, the user has input their credentials into the system enabling the system to gain access to the information in the user's account. Alternatively, in step 410, the system can ping the utility provider to provide such information by electronic mail or other tangible, deliverable means if no user credentials are in place or accessible. Step 420 provides for current and future initiatives that may require a utility provider to supply usage data and other information.

In step 425, the calendar interface can be configured by a user. The calendar interface controls the frequency with which the data is sourced or retrieved by the system. There are preferably a number of preset and customizable options to give users a wide array of flexibility in these data retrievals. Different utilities can be set on different frequencies if need be. Thus, the data is always present in the system when needed by the user.

In step 430, the system checks to see if this is the first time the system is accessing the data associated with a particular property.

In step 435, since the data has been previously retrieved only data that has been changed or updated since the last retrieval is pulled by the system. This reduces the workload and storage requirements of the system as a whole.

In step 440, the system has determined that this is the first time the specific utility data is being retrieved for a particular property. Thus, the system will look to retrieve both current and historical data. The current data is data valid as of the last six months, whereas historical data may be data over six months old and may be up to two years old or older. However, the system has to check to see which type and how much data is actually available based on a given utility provider.

In step 450, the system checks to see if the historical data can be retrieved. If the data can, in fact, be retrieved the data is retrieved or sourced in step 445. Alternatively, the historical data may not be readily available or the system cannot immediately retrieve it for various reasons. In step 455, the system sends a request to the provider to send the historical data to the entity or user in question. This enables the utility provider to provide the data in both paper and electronic formats to the user.

In step 460, the above described process is repeated for all the utilities prescribed to a particular property.

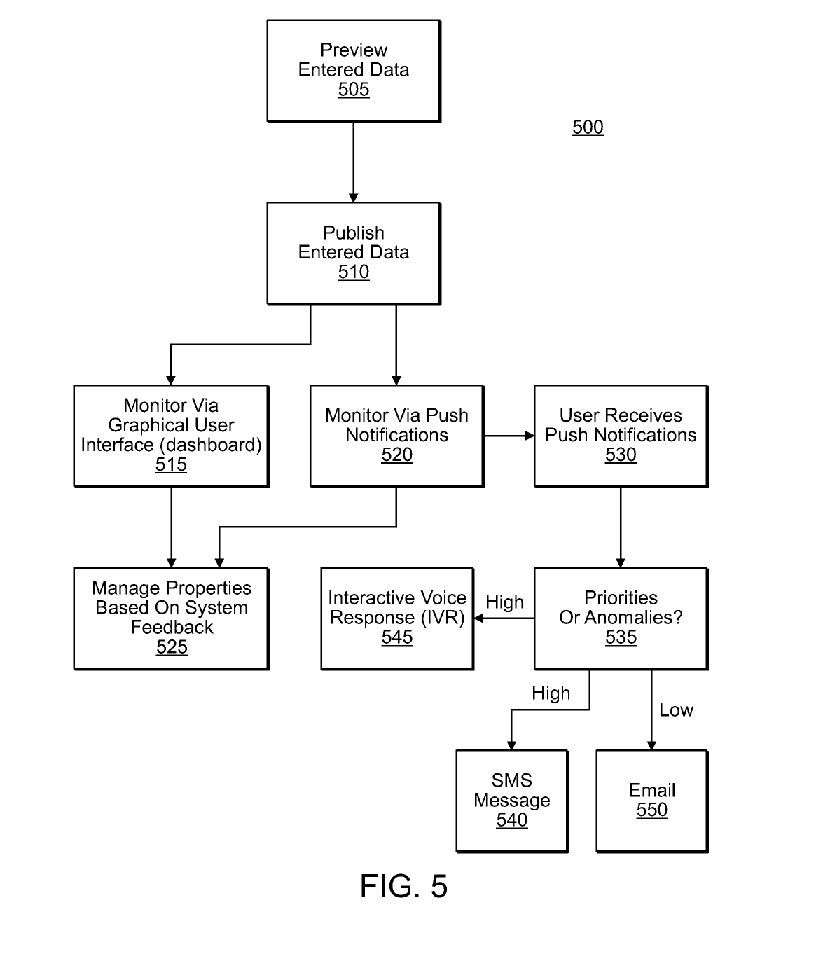

Now that the portfolio is built and the data provisioned, a user can now actively or passively monitor the portfolio. Referring now to FIG. 5, there is a flowchart illustrating a monitoring process 500 associated with an embodiment of the present invention.

In step 505, a user can preview the entered data. This allows the user to view and visualize the selections made in assigning utilities and utility providers to a particular property. Edits or modifications can be made to a particular set up if there is incorrect or incomplete information contained herein.

In step 510, the entered data can then be published by the user. This effectively enters the data into operation and enables monitoring of the data by the system. The property will appear in the monitoring dashboard (see below) and can be removed as needed.

In steps 515 and 520 there are two methods by which one can monitor their portfolio. In step 515, the portfolio is monitored by a graphical user interface or dashboard. The dashboard is accessed through any traditional web browser, mobile/web application, electronic device, and the like or any combination thereof.

The properties each appear in the dashboard with overlays and information obtainable therefrom. The properties may be actively monitored to see how a particular property is performing and whether the property is up to par for other comparable structures in that approximate locale. A user can readily discern any properties that are exceeding or not meeting expectations and can determine the cause of such performances thereby enabling changes to be made to each individual property. For example, a user may find that a particular heating bill is too high due to gaps in particular areas of the property. Repairs can then be made to curb this issue. In step 535, the properties as described are managed on system feedback and performances displayed in the dashboard.

In step 520, a user may choose to take a more passive role and monitor the dashboard via push notifications. These notifications can be sent to any electronic and/or computing device to enable real time alerts and updates on any of the published properties. Decisions and managing of the properties can then be achieved as shown in step 525.

In step 530, a user receives a push notification. The method of delivery may depend on a priority ranking prescribed to a certain value or event as understood by the system. The system checks, in step 535, for any priorities or abnormalities in generating a push notification. As shown for exemplary purposes only, if the event is determined to be a “low” priority event then in step 550 an email notification is sent to the user.

However, a more high priority event may result in a SMS message, as shown in step 540, or a phone call with interactive voice response capabilities, as shown in step 545. As stated, the priority prescribed to a particular performance or anomaly or other event may largely rely on an individual user's settings for what they feel to be most important.

Although this invention has been described with a certain degree of particularity, it is to be understood that the present disclosure has been made only by way of illustration and that numerous changes in the details of construction and arrangement of parts may be resorted to without departing from the spirit and the scope of the invention.

What is claimed is:

1. A property management system comprising:
an audiovisual display for displaying and communicating desired content;
a processor based computing device capable of being connected to a network;
a computer readable storage medium storing one or more programs for execution by the processor based computing device,
the one or more programs being capable of sourcing data from at least one utility provider associated with at least one property,
wherein the sourced data is analyzed and compared to benchmark data, and
wherein the sourced data is capable of being monitored in real time.

2. The property management system of claim 1 wherein a user can create at least one threshold event to be monitored by the system.

3. The property management system of claim 2 wherein the user receives a notification when the at least one threshold event is met.

4. The property management system of claim 2 wherein the threshold event is set in response to a comparison between the sourced data and the benchmark data.

5. The property management system of claim 1 wherein the one or more programs is a mobile application, web application, computer software, or any combination thereof.

6. The property management system of claim 1 wherein the processor based computing device is a lap top computer, desktop computer, PDA, cellular phone, gaming system, smart watch, media player, multimedia player, tablet, or any combination thereof.

7. The property management system of claim 1 wherein the one or more programs adapts to and modifies the appearance of a graphical user interface depending on the processor based computing device used to access the system.

8. The property management system of claim 1 wherein the one or more programs is used to create a property management portfolio.

9. The property management system of claim 7 wherein a property management portfolio comprises at least one property and at least one utility provider prescribed to the at least one property.

10. A property management system comprising:
a processor based computing device capable of being connected to a network;
a computer readable storage medium storing one or more programs for execution by the processor based computing device,
the one or more programs being capable of sourcing data from more than one utility provider associated with more than one property,
wherein the sourced data is used to create at least one property portfolio containing usage and expenditure data for the more than one utility provider for each of the more than one property.

11. The property management system of claim 10 wherein the more than one program can be configured for users of varying skill levels.

12. The property management system of claim 10 wherein the usage and expenditure data is monitored through a graphical user interface or push notifications.

13. A method of building a property management portfolio, the method comprising:
providing a computer readable storage medium storing one or more programs for execution by one or more processors;
accessing the one or more programs via a processor based computing device capable of being connected to a network,
wherein content access is determined by user credentials supplied by a user;
a user selecting a location of at least one property;
the user selecting at least one utility associated with the at least one property; and
the user selecting at least one utility service provider associated with the at least one utility.

14. The method of claim 13 wherein the first selecting step through the third selecting step is repeated for each utility associated with a particular property.

15. The method of claim 13 further comprising the step of:
the one or more programs automatically sourcing data associated with each of the at least one property's utility service providers.

16. The method of claim 14 wherein a system calendar configures the frequency by which the data is sourced.

17. The method of claim 14 wherein the sourced data comprises current data, historical data, or any combination thereof.

18. The method of claim 13 wherein the one or more programs is accessed through a web browser, web application, mobile application, computer software, or any combination thereof.

19. The method of claim 13 further comprising the step of:
the user receiving a notification based on the sourced data associated with the at least one property.

20. The method of claim 15 wherein if it is the first time the system sources the data, then both current and historical data is sourced, and wherein if it is not the first time the system sources the data, then only the data modified since the last update is sourced.
